(19) United States
(12) Patent Application Publication
(10) Pub. No.: US 2026/0015270 A1
(43) Pub. Date: Jan. 15, 2026

(54) MICROBIAL SUPPORTS FOR TREATING WATER

(71) Applicant: 1489344 ALBERTA LTD., Grande Prairie (CA)

(72) Inventor: Rhonda Hewko, Grande Prairie (CA)

(21) Appl. No.: 19/078,234

(22) Filed: Mar. 12, 2025

(30) Foreign Application Priority Data
Jul. 12, 2024 (CA) 3248452

(51) Int. Cl. C02F 3/10; C02F 3/00

(52) U.S. Cl. CPC C02F 3/109; C02F 3/005; C02F 3/106; C02F 3/108

(57) ABSTRACT

A microbial support for use in treating contaminated water includes a panel having a planar surface, and carbon-containing pieces of material carried by the panel. The panel defines an array of holes in the planar surface, the holes having an average size of 0.25 cm² or greater, and the array of holes comprising 10-80% of an area of the planar surface, the panel being made from a thermoplastic material that is chemically inert relative to the water being treated. The pieces of material are embedded in the thermoplastic material such that the pieces of material are structurally supported by the thermoplastic material and partially exposed on the planar surface.

### TECHNICAL FIELD

This relates to a microbial support, and in particular, a microbial support for use in treating contaminated water.

### BACKGROUND

Bioreactors, constructed wetlands, or other water bodies are used to treat wastewater, surface water, wetland, or stormwater by removing organic matter, typically to meet standards necessary to allow the water to be discharged. One type of bioreactor uses substrates such as membranes as supports for microbial growth. In some bioreactors, such as an electrochemical bioreactor, a voltage or current may be applied to membranes that are submerged within the wastewater.

An example of a bioreactor with microbial support films is described in Canadian patent no. 2,992,337 and U.S. Pat. No. 10,981,817 (Tartakovsky et al.) entitled “Wastewater treatment with in-film microbial heating”.

### SUMMARY

According to an aspect, there is provided a microbial support for use in treating wastewater in a water body. The microbial support comprises a panel having a planar surface, the panel defining an array of holes in the planar surface. The holes may have an average size of 1 cm² or greater, and the array of holes may comprise 10-80% of an area of the planar surface. The panel may be made from a thermoplastic material that is chemically inert relative to the wastewater being treated. Carbon-containing pieces of material are carried by the panel, where the pieces of material are embedded in the thermoplastic material such that the pieces of material are structurally supported by the thermoplastic material and partially exposed on the planar surface.

According to an aspect, there is provided a method of forming a microbial support for a water body for treating wastewater, the method comprising the steps of: distributing carbon-containing pieces of material adjacent to a planar surface of a panel, the panel being made from a thermoplastic material that is chemically inert relative to the surface water, stormwater, wetland, or wastewater, the panel defining an array of holes, the holes having an average size of 1 cm² or greater, and the array of holes comprising 10-80% of an area of the planar surface; heating the panel to above a softening temperature of the thermoplastic material; and causing the pieces of material to become partially embedded within the panel such that the pieces of material are embedded in the planar surface such that the pieces of material are structurally supported by the thermoplastic material and partially exposed on the planar surface.

According to other aspects, the microbial support and/or the method may comprise one or more of the following features, alone or in combination: the panel may comprise a lattice structure; the holes in the array may be separated by at least 1 cm; the pieces of material may comprise activated carbon, metallurgical coke, carbon fibers, a carbon aggregate, biochar, or combinations thereof, the pieces of material may have an average length of between 0.5-5 mm, or are granules having an average length of between 0.5-5 mm, the pieces of material may have an average length of between 1-2 mm, or are granules having an average mesh size of between 1-2 mm; the pieces of material may be electrically conductive, and a density of the pieces of material on the planar surface may be sufficient to form an electrically conductive layer; the pieces of material may form a porous layer on the planar surface of the panel; the pieces of material may be in direct contact with and solely supported by the thermoplastic material; the pieces of material may be embedded in the planar surface on a first side of the panel and a second planar surface on a second side of the panel. According to an aspect, there is provided a microbial support for use in treating contaminated water, the microbial support comprising a panel having a planar surface and carbon-containing pieces of material carried by the panel. The panel defines an array of holes in the planar surface, the holes having an average size of 0.25 cm² or greater, and the array of holes comprising 10-80% of an area of the planar surface. The panel is made from a thermoplastic material that is chemically inert relative to the water being treated. The carbon-containing pieces of material are embedded in the thermoplastic material such that the pieces of material are structurally supported by the thermoplastic material and partially exposed on the planar surface.

According to other aspects, the microbial support may comprise one or more of the following features, alone or in combination: the panel may comprise a lattice structure, wherein the holes in the array are separated by at least 1 cm, the area of the planar surface may be between 0.2 m³ and 2.5 m³, and the panel may have a thickness of between 3 mm and 10 mm; the pieces of material may comprise activated carbon, metallurgical coke, carbon fibers, a carbon aggregate, biochar, or combinations thereof; the pieces of material may have an average length of between 0.5-8 mm, or may be granules having an average length or mesh size of between 0.5-8 mm; the pieces of material may be electrically conductive, and a density of the pieces of material on the planar surface is sufficient to form an electrically conductive layer; the pieces of material may be in direct contact with, and solely supported by, the thermoplastic material of the panel; and the pieces of material may be embedded in the planar surface on a first side of the panel and a second planar surface on a second side of the panel.

According to an aspect, there is provided a method of forming a microbial support used for treating contaminated water, the method comprising the steps of: distributing carbon-containing pieces of material adjacent to a planar surface of a panel, the panel being made from a thermoplastic material that is chemically inert relative to the contaminated water, the panel defining an array of holes, the holes having an average size of 1 cm² or greater, and the array of holes comprising 10-80% of an area of the planar surface; heating the panel to above a softening temperature of the thermoplastic material; and causing the pieces of material to become partially embedded within the panel such that the pieces of material are embedded in the planar surface such that the pieces of material are structurally supported by the thermoplastic material and partially exposed on the planar surface.

According to other aspects, the method may comprise one or more of the following features, alone or in combination: the panel may comprise a lattice structure, wherein the holes in the array are separated by at least 1 cm; the pieces of material may comprise activated carbon, metallurgical coke, carbon fibers, a carbon aggregate, biochar, or combinations thereof; the pieces of material may have an average length of between 0.5-8 mm, or may be granules having an average length or mesh size of between 0.5-8 mm; the pieces of material may be electrically conductive, and a density of the pieces of material on the planar surface is sufficient to form an electrically conductive layer; the pieces of material may be in direct contact with and solely supported by the thermoplastic material; the pieces of material may be embedded in the planar surface on a first side of the panel and a second planar surface on a second side of the panel; and the pieces of material may be partially embedded within the panel solely under the force of gravity of the pieces of material or the panel.

According to an aspect, there is provided a system for treating contaminated water, comprising a plurality of microbial supports according to one or more aspects described above. The plurality of microbial supports may be positioned in a tank of a bioreactor, a septic tank, a natural body of water, or a constructed body of water. The plurality of microbial supports may be positioned in parallel spaced relation or diverge from a central area. The array of holes of adjacent panels may be offset to define a non-linear flow path through the plurality of microbial supports. Where the pieces of material are electrically conductive, and a density of the pieces of material on the planar surfaces is sufficient to form an electrically conductive layer, the system may further comprising an electrical power source that applies an electric current conditioned to promote microbial growth. The system may be an integrated activated sludge system (IFAS), a fixed film activated sludge system (FFAS), a bioelectrochemical anaerobic sewage treatment (BEAST) system, a constructed water body, or a natural water body. The system may have a container that houses the plurality of microbial supports.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a front plan view of a panel.

FIG. 2 is a front plan view of an alternative panel.

FIG. 3 is a detailed front plan of a panel with embedded pieces of material.

FIG. 4 is a side elevation view of a panel being heated.

FIG. 5 is a perspective view of a pair of panels with a voltage applied therebetween.

FIG. 6 is a side elevation view of vertically-oriented microbial supports in a treatment tank.

FIG. 7 is a side elevation view of horizontally-oriented microbial supports in a treatment tank.

FIG. 8 is a top plan view of a cylindrical treatment tank.

FIG. 9 is a side elevation view of microbial supports in a body of water.

### DETAILED DESCRIPTION OF PREFERRED EMBODIMENTS

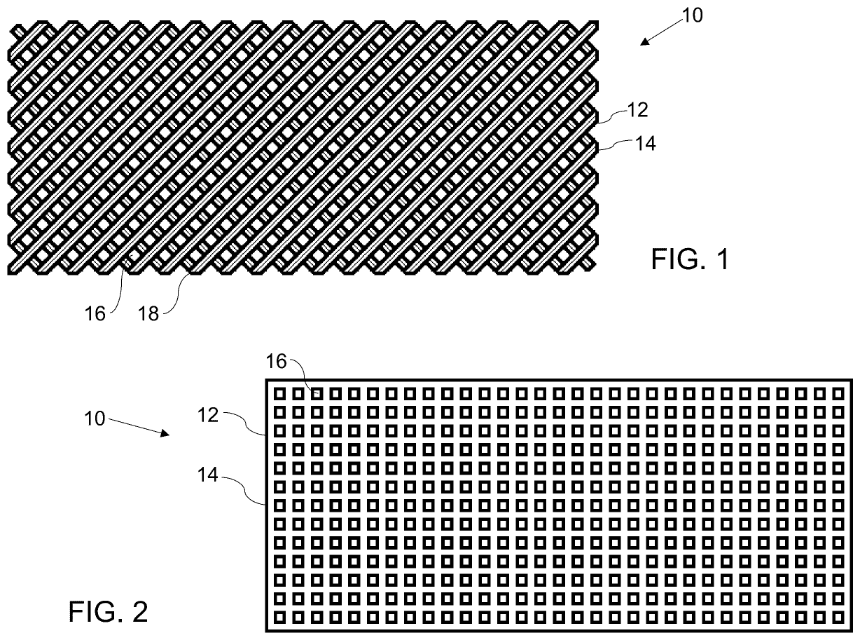

A microbial support, generally identified by reference numeral 10, will now be described with reference to FIG. 1 through 9. Microbial support 10 is intended to be used when treating water that has contaminants, where the contaminants include those that may be removed through a reaction that is promoted by microbial support 10 or in a bioreactor. It will be understood that the water may include other contaminants that are not able to be treated in this manner. It will also be understood that “treated” does not require the water to be purified. In some cases, water may be treated to remove contaminants to below a required threshold in order to be disposed of or returned to the environment, such as may be required in a household septic system, or in a given phase of a water treatment plant. Microbial support 10 may be used, for example, to treat wastewater in a bioreactor. A bioreactor may include any construction designed to support a biological reaction, such as a septic tank or similar structure, a lagoon of waterway that is part of a wastewater treatment plan, a constructed wetland, etc. Microbial support 10 may also be used to treat other types of water in other applications, such as water in a natural or constructed body of water. These terms are intended to include any body of water that may be naturally found in nature or as a result of human intervention or construction, and may include wetlands, constructed wetlands, lakes, water reservoirs, stormwater, etc. The terms bioreactor and body of water are intended to include any volume of water able to support a biological reaction and sized or configured to receive a microbial support as described herein.

Referring to FIG. 1, microbial support 10 includes a panel 12 having a planar surface 14. Panel 12 defines an array of holes 16 in planar surface 14. Panel 12 may be a lattice or lattice structure as shown in FIG. 1, preferably planar, where holes 16 are formed by interwoven strands 18. Referring to FIG. 2, panel 12 may be a solid sheet of material with holes 16 cut into panel 12. Holes 16 may be square, rectangular, diamond shaped, round, etc. Panel 12 may take other forms, and holes 16 may have different shapes. Holes 16 may be distinguished from the pores that are typically formed in this type of substrate as they are relatively large relative to a typical pore size. For example, holes 16 may have an average size of 0.25 cm² or greater, where the array of holes 16 makes up between 10-80% of an area of planar surface 14. In the depicted example, holes 16 make up about 20-30% of the area of planar surface 14. Holes 16 may be separated by material that has a width of at least 1 cm. The total area (i.e. including holes 16) of the planar surface of panel 12 may be between, for example, 0.2 m³ and 2.5 m³, and panel 12 may have a thickness, for example, of between 3 mm and 10 mm.

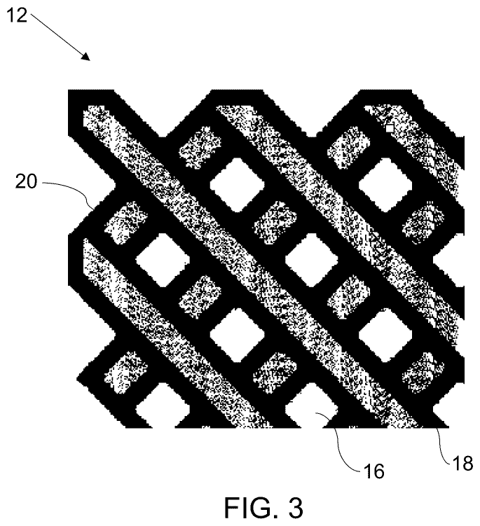

Referring to FIG. 3, panel 12 has carbon-containing pieces of material 20 embedded in planar surface 14. Pieces of material 20 may be embedded in panel 12 such that they are structurally supported by panel and partially exposed on planar surface 14. Panel 12 may be made from a thermoplastic material. This allows pieces of material 20 to become embedded when panel 12 is heated to soften planar surface 14 sufficiently to allow pieces of material 20 to become embedded within planar surface 14. The pieces of material 20 may be in direct contact with and entirely supported by panel 12, without any additional adhesive or structural material to bind pieces of material 20 to panel 12. For example, it has been found that using an adhesive may be detrimental to the performance of panel 12, as some adhesives are water soluble or otherwise degrade an aqueous environment or may degrade in the presence of certain chemicals and compounds that may be found in the wastewater to be treated, such as H₂S. In addition, a layer of adhesive or other structural material may be electrically insulating, which may decrease the efficiency of panel 12 when pieces of material 20 are electrically conductive. As panel 12 may be made from material that is chemically inert relative to the components in the wastewater being treated, it may be beneficial to avoid introducing other components that may be affected by the wastewater being treated.

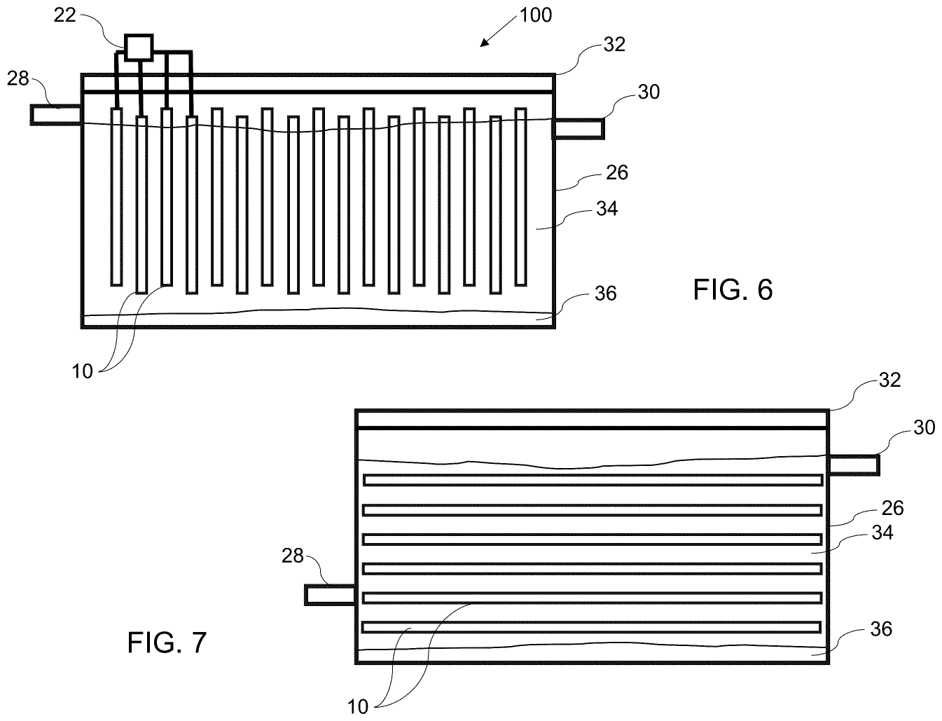

Planar surface 14 that carries pieces of material 20, i.e., with pieces of material 20 embedded therein, may form a porous layer that supports microbial growth on panel 12. This may be based on the porosity of pieces of material 20. If pieces of material 20 are electrically conductive, the density of pieces of material 20 may be sufficient to ensure electrical contact between adjacent pieces of material 20, such that an electrically conductive layer may be formed. Referring to FIG. 5, this may be useful where a voltage is applied between adjacent panels 12 as shown, or between a panel 12 and another conductive material, which may or may not be a panel 12 as described herein. As shown in FIG. 5, a voltage or current may be applied using an electrical power source 22. Electrical power source 22 may apply a direct current or an alternating current. Alternatively, an AC or DC current source may be used in place of voltage source 22. Referring to FIG. 6, this may be useful where panels 12 are used in an electrical bioreactor 100. An electrically conductive layer may be used to promote the growth of electrophilic bacteria as a biofilm, or for other purposes, depending on the type of bioreactor in which panels 12 are used. It has been found that an applied voltage of less than 1.8 V is effective in promoting growth, with the effectiveness becoming limited below 1 V. In some examples, suitable results have been obtained using a voltage of about 1.4-1.5 V. Bioreactor 100 may be operated as an anaerobic bioreactor, and microaeration (not shown) may be used to increase and/or control the oxygen content of the water being treated. This may be done to help convert CH₄ to CO₂, and/or oxidize H₂S or other contaminants, while maintaining dissolved oxygen levels low enough to keep the system anaerobic.

In addition to promoting the growth of a biofilm, a suitably-designed bioreactor 100, including suitably designed conductive panels 12 and power source 22, may allow panels 12 to be self-cleaning, in that accumulation of precipitates and/or bacterial die-off resulting from the treatment of effluent in the water being treated will tend to eventually detach, or to fall off panels 12.

In addition to a suitable voltage, panels 12 may be suitably spaced to allow debris to settle to the bottom of container 26 without obstructing the space between panels 12. It has been found that adequate results have been achieved using a minimum gap of about 3 mm between adjacent panels. A larger gap reduces the number of panels 12, and therefore the cost, but also decreases the available treatment surface area. In one example, adequate results were achieved using a gap of about 25 mm. A gap of up to about 150 mm may also be used. The spacing of the gap may also depend on the surface roughness of panels 12 and may need to account for the coarseness of pieces of material 20. For example, the size of the gap may be increased where pieces of material 20 protrude significantly from panels 12.

Pieces of material 20 may be carbon-containing material, as it has been found that carbon has beneficial properties as a microbial support. Examples of suitable materials may include activated carbon, carbon black, metallurgical coke, carbon fibers, a carbon aggregate, biochar, or combinations thereof.

The pieces of material may have different shapes and structures, some of which may be irregular. For example, the pieces of material may be powder, particles, granules, fibres, flakes, and the like. As such, when referring to dimensions, the “length” refers to the major, i.e., the largest dimension of each piece. In other cases, the size of the pieces may be defined by a mesh size. The pieces of material may have an average length or mesh size of between 0.5-5 mm. The size may affect the ability of the pieces to become embedded and to provide an electrically conductive layer, where desirable to do so. In one example, granules having an average mesh size of about 2-3 mm was found to provide adequate results.

The material for panel 12 and for pieces of material 20 may be selected to facilitate fabrication. For example, pieces of material 20 may be selected to be stable within the temperature range required to soften panel 12 sufficiently to permit pieces of material 20 become embedded in panel 12. Similarly, the material of panel 12 may be selected to ensure panel 12 is stable in the operating temperature ranges that may be encountered during use. Panel 12 may be made from a thermoplastic, such as polyethylene. For example, panel 12 may be made from HDPE (high density polyethylene), or other suitable material with desired material properties. The material selected may be chemically inert relative to the components that are expected to be found in the wastewater. A material will be considered inert if it retains structural integrity for the expected lifecycle of the product without undue servicing.

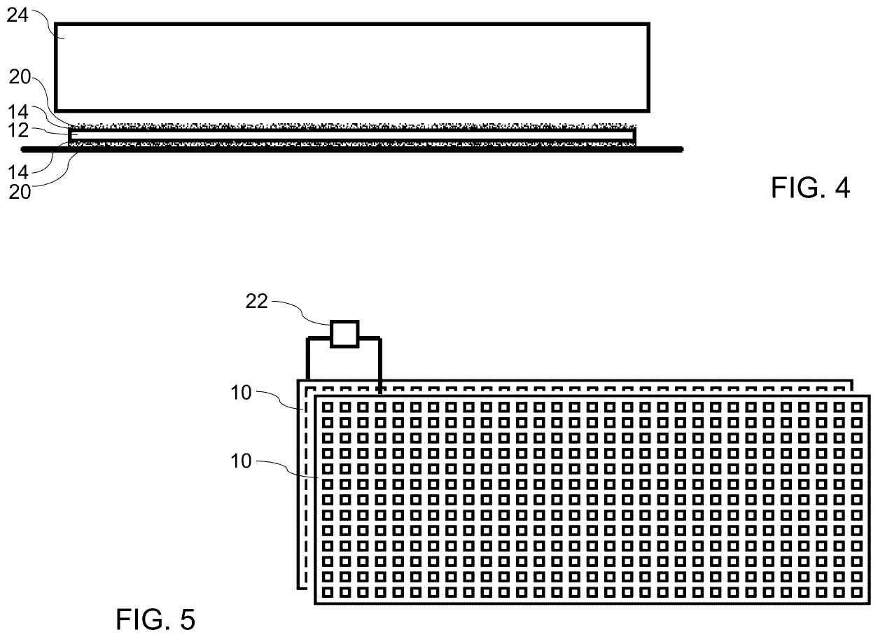

Referring to FIG. 4, an example of how panels microbial support 12 may be made is depicted. Panels 12 may be pre-formed or formed as part of the process (not shown). Panels 12 may be positioned within or adjacent to a heat source 24, such as an oven, with pieces of material 20 distributed adjacent to an outer surface on one or both sides of panel 12. Panels 12 may be heated from both sides Panels 12 are then heated to soften material sufficiently to allow pieces of material 20 to become embedded in one or both faces of panel 12. Where pieces of material 20 are only distributed on one side of panel 12, it may be necessary to only heat that side of panel 12. Where pieces of material 20 are to be distributed on both sides, both sides may be heated simultaneously, or sequentially. During heating, pieces of material 20 may be distributed on top of panel 12, or below. Once pieces of material 20 are properly embedded, panels 12 are then removed from the heat, or heat source 24 is deactivated, and panels 12 are allowed to cool and harden such that pieces of material 20 are structurally mounted to panels 12 as described above. In some cases, it may be necessary to apply an additional weight (not shown) to panels 12 or to pieces of material 20.

There will now be described some examples of how microbial supports 10 may be used.

Referring to FIG. 6, microbial supports 10 may be disposed in a container 26 that has an inlet 28 and an outlet 30. Container 26 may have a lid 32 to provide access to the interior, such as during installation, cleaning, servicing, etc. Container 26 and microbial supports 10 may be adapted for different purposes, and may be used as, or integrated into, a bioreactor, an integrated activated sludge system (IFAS), fixed film activated sludge (FFAS) system, a rotating biological contactor (RBC), etc. If required, an electrical power source 22 (as shown in FIG. 5) may be integrated into container 26.

Container 26 may have a liquid layer 34 and a sediment layer 36. Liquid layer 34 represents the contaminate water to be treated, such as wastewater or the like. The microbial supports 10 may be raised above the bottom of container 26 to provide a settling area with sufficient space for sediment layer 324 to collect. Container 26 may be designed to allow for the removal of sediment (not shown), as is known in the art. The height of microbial supports 10 may also be adjustable to account for changing conditions in container 26, such as changing liquid level. The spacing of microbial supports 10 may also be selected based on the intended use and may be adjustable. As depicted, the height of microbial supports 10 is staggered to represent that the perforations (not shown) in adjacent supports 10 may be offset to create a non-linear flow path from inlet 28 to outlet 30, although a similar effect may be achieved by an appropriate design of microbial supports 10 as placed in series, i.e. by providing different sizes and/or locations of the perforations in adjacent microbial supports 10. In some examples, multiple supports 10 may be used rather than a single microbial support 10 to extend across the entire width or length of container 26.

As shown in FIG. 5, microbial supports 10 act as separated, perforated dividers in container 26. In some cases, it may be desirable to also include some solid dividers to force water to flow over or under a given divider, such as in the middle of a tank, to either increase the flow path, or to create different chambers within container 26, such as an initial chamber where the majority of settling occurs from sediment carried by the water, or that results from the treatment process, and a final chamber where treated water is removed by outlet 30.

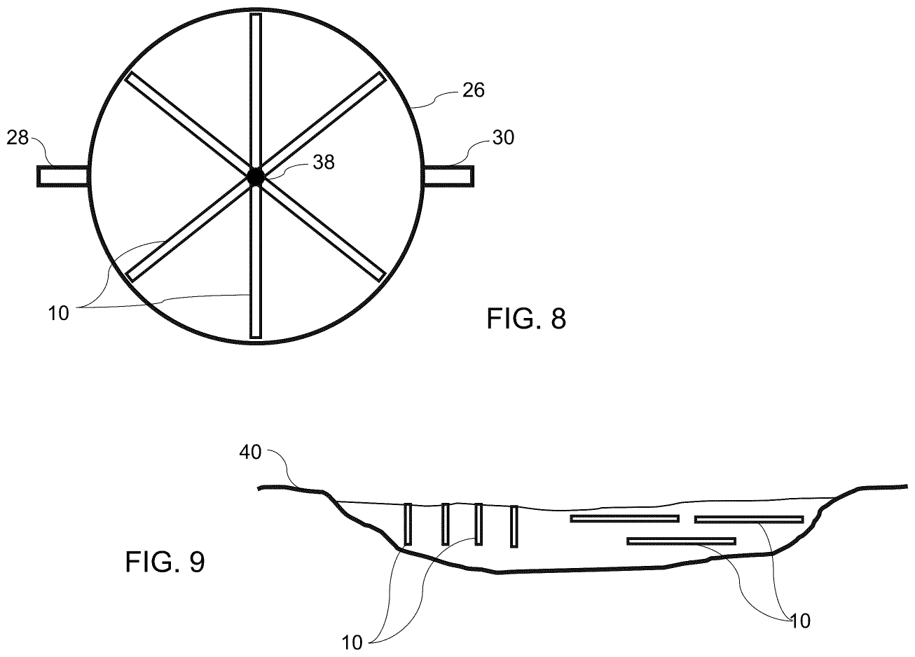

It will be understood that the orientation and relative position of microbial supports 10 may vary from the vertical orientation in a rectangular container 26 shown in FIG. 6. For example, referring to FIG. 7, microbial supports 10 may be horizontal, or, referring to FIG. 8, may be spaced radially in a cylindrical container 26. In some cases, the position of inlet 28 and outlet 30 may be designed to induce a certain flow of contaminated water. For example, by positioning inlet 28 toward the bottom of container 26 and outlet 30 toward the top, contaminated water must flow up. In the case of horizontal microbial supports 10 as shown in FIG. 7, this will cause the water to flow through microbial supports 10. In some examples, container 26 and inlet 28 and outlet 30 with microbial supports 10 may be designed to require, or not required, vertical flow through or around microbial supports 10. In some example, microbial supports 10 may be orientated parallel to a direction of travel (either horizontally or vertically) rather than transversely. In some examples, it may be beneficial to induce more movement of the contaminated water relative to microbial supports 10, such as by inducing a current in the contaminated water or by moving microbial supports 10. With respect to FIG. 8, this may involve a pump (not shown) that causes a current within container 26, or by rotating a common shaft 38 that carries microbial supports 10, such as in a rotating biological contactor (RBC). As will be understood, container 26 and microbial supports 10 may be arranged to achieve or encourage a parallel flow, a transversal fluid flow, a rotating flow, a raceway flow, or combinations thereof.

Referring to FIG. 9, similar design principles to those discussed above may be applied to a body of water 40, either natural or constructed. In some cases, modifications to the natural body of water 40 may be restricted, which may limit certain design options. There may or may not be a defined inlet and/or outlet, depending on body of water 40, and microbial supports 10 may be positioned to take this into account. In the depicted example, microbial supports 10 are shown vertically and horizontally oriented. The orientation may be based on the characteristics of natural body of water 40 and the goal of the treatment. The orientation and position may also depend on available anchoring methods. In some examples, buoyant devices may be used in combination with cables (not shown) to achieve a desired position and depth in body of water 40.

The size and number of microbial supports 10 may be scalable to fit within bodies of water, whether container 26 as shown for example in FIG. 6 or 8, or body of water 40 as shown for example in FIG. 9. The size and number of microbial supports 10 may require other modifications, such as multiple, or suitably-sized, electrical power supports 22 where appropriate.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings but should be given the broadest interpretation consistent with the description as a whole.

What is claimed is:

1. A microbial support for use in treating contaminated water, the microbial support comprising:
a panel having a planar surface, the panel defining an array of holes in the planar surface, the holes having an average size of 0.25 cm² or greater, and the array of holes comprising 10-80% of an area of the planar surface, the panel being made from a thermoplastic material that is chemically inert relative to the water being treated; and
carbon-containing pieces of material carried by the panel, the pieces of material being embedded in the thermoplastic material such that the pieces of material are structurally supported by the thermoplastic material and partially exposed on the planar surface.

2. The microbial support of claim 1, wherein the panel comprises a lattice structure, wherein the holes in the array are separated by at least 1 cm.

3. The microbial support of claim 1, wherein the pieces of material comprise activated carbon, carbon black, metallurgical coke, carbon fibers, a carbon aggregate, biochar, or combinations thereof.

4. The microbial support of claim 1, wherein the pieces of material have an average length of between 0.5-8 mm, or are granules having an average length or mesh size of between 0.5-8 mm.

5. The microbial support of claim 1, wherein the pieces of material are electrically conductive, and a density of the pieces of material on the planar surface is sufficient to form an electrically conductive layer.

6. The microbial support of claim 1, wherein the pieces of material are in direct contact with, and solely supported by, the thermoplastic material of the panel.

7. The microbial support of claim 1, wherein the pieces of material are embedded in the planar surface on a first side of the panel and a second planar surface on a second side of the panel.

8. A method of forming a microbial support used for treating contaminated water, the method comprising the steps of:
distributing carbon-containing pieces of material adjacent to a planar surface of a panel, the panel being made from a thermoplastic material that is chemically inert relative to the contaminated water, the panel defining an array of holes, the holes having an average size of 1 cm² or greater, and the array of holes comprising 10-80% of an area of the planar surface;
heating the panel to above a softening temperature of the thermoplastic material; and
causing the pieces of material to become partially embedded within the panel such that the pieces of material are embedded in the planar surface such that the pieces of material are structurally supported by the thermoplastic material and partially exposed on the planar surface.

9. The method of claim 8, wherein the panel comprises a lattice structure, wherein the holes in the array are separated by at least 1 cm.

10. The method of claim 8, wherein the pieces of material comprise activated carbon, carbon black, metallurgical coke, carbon fibers, a carbon aggregate, biochar, or combinations thereof.

11. The method of claim 8, wherein the pieces of material have an average length of between 0.5-8 mm, or are granules having an average length or mesh size of between 0.5-8 mm.

12. The method of claim 8, wherein the pieces of material are electrically conductive, and a density of the pieces of material on the planar surface is sufficient to form an electrically conductive layer.

13. The method of claim 8, wherein the pieces of material are in direct contact with and solely supported by the thermoplastic material.

14. The method of claim 8, wherein the pieces of material are embedded in the planar surface on a first side of the panel and a second planar surface on a second side of the panel.

15. The method of claim 8, wherein the pieces of material are partially embedded within the panel solely under the force of gravity of the pieces of material or the panel.

16. A system for treating contaminated water, comprising:
a plurality of microbial supports, each microbial support comprising:
a panel having a planar surface, the panel defining an array of holes in the planar surface, the holes having an average size of 0.25 cm² or greater, and the array of holes comprising 10-80% of an area of the planar surface, the panel being made from a thermoplastic material that is chemically inert relative to the contaminated water; and
carbon-containing pieces of material carried by the panel, the pieces of material being embedded in the thermoplastic material such that the pieces of material are structurally supported by the thermoplastic material and partially exposed on the planar surface;
wherein the plurality of microbial supports are positioned in spaced relation in a body of water such that the planar surfaces of adjacent panels of the plurality of microbial supports are facing each other.

17. The system of claim 16, wherein the plurality of microbial supports is positioned in a tank of a bioreactor, a septic tank, a natural body of water, or a constructed body of water.

18. The system of claim 16, wherein the plurality of microbial supports are positioned in parallel spaced relation or diverge from a central area.

19. The system of claim 16, wherein the array of holes of adjacent panels are offset to define a non-linear flow path through the plurality of microbial supports.

20. The water treatment apparatus of claim 16, wherein a spacing of the plurality of microbial supports is adjustable, and wherein the plurality of microbial supports is positioned to define a settling area below the panels.

21. The system of claim 16, wherein the pieces of material are electrically conductive, and a density of the pieces of material on the planar surfaces is sufficient to form an electrically conductive layer, the system further comprising an electrical power source that applies an electric current conditioned to promote microbial growth.

22. The system of claim 16, wherein the system is an integrated activated sludge system (IFAS), a fixed film activated sludge system (FFAS), a bioelectrochemical anaerobic sewage treatment (BEAST) system, a constructed water body, or a natural water body.

23. The system of claim 16, further comprising a container that houses the plurality of microbial supports.
